(19) United States
(12) Patent Application Publication
(10) Pub. No.: US 2026/0004973 A1
(43) Pub. Date: Jan. 1, 2026

(54) CAPACITOR AND METHOD OF MANUFACTURING THE SAME

(71) Applicant: TAIYO YUDEN CO., LTD., Tokyo (JP)

(72) Inventor: Yuta SAITO, Tokyo (JP)

(21) Appl. No.: 19/319,041

(22) Filed: Sep. 4, 2025

Related U.S. Application Data
(63) Continuation of application No. PCT/JP2024/003762, filed on Feb. 5, 2024.

(30) Foreign Application Priority Data
Mar. 16, 2023 (JP) 2023-042012

(51) Int. Cl. H01G 4/12; H01G 4/008; H01G 4/248; H01G 13/04

(52) U.S. Cl. CPC H01G 4/1227; H01G 4/0085; H01G 4/248; H01G 13/04

(57) ABSTRACT

One object is to improve the insulation reliability of capacitors having dielectric layers containing rare earth elements. An aspect of the present disclosure provides a capacitor including a body, a first external electrode provided on the body, and a second external electrode provided on the body. The body has a first internal electrode layer, a second internal electrode layer, and a dielectric layer disposed between the first internal electrode layer and the second internal electrode layer. The dielectric layer contains crystal grains of barium titanate. The crystal grains each include a core portion and a shell portion covering the core portion. The concentration of Ho in the shell portion is from 0.5 at % to 5 at %. The concentration of Ni and the concentration of Fe in the shell portion are from 0.3 at % to 3 at %.

### CROSS-REFERENCE TO RELATED APPLICATIONS

This is a continuation application of a PCT application No. PCT/JP2024/3762 filed on Feb. 5, 2024, which is based on and claims the benefit of priority from Japanese patent Application serial No. 2023-042012 (filed on Mar. 16, 2023). The contents of the PCT and Japanese applications are hereby incorporated by reference in their entirety.

### TECHNICAL FIELD

The disclosure herein relates mainly to a capacitor and a method of manufacturing the capacitor. The disclosure herein also relates to a circuit module with the capacitor and an electronic device with the circuit module.

### BACKGROUND

Capacitors are installed in various electronic devices. A capacitor has a capacitance-generating portion that includes a dielectric layer and internal electrode layers that sandwich the dielectric layer. It is known that various characteristics of a capacitor can be improved by adding rare earth elements to the dielectric layer, which is mainly composed of barium titanate. For example, Japanese Patent Application Publication No. 2014-090119 discloses that the capacitance and high-temperature load life of a capacitor can be improved by adding rare earth elements to the dielectric layer, which is mainly composed of barium titanate.

As the content of rare earth elements in the dielectric layer increases, the proportion of barium titanate with oxygen defects in the dielectric layer increases. The oxygen defects in barium titanate cause a decrease in the insulation reliability of capacitors. Therefore, there is a need to improve insulation reliability in capacitors that contain rare earth elements in the dielectric layer.

### SUMMARY

It is an object of the present disclosure to solve or alleviate at least part of the drawback mentioned above. One of the particular objects of the present disclosure is to improve the insulation reliability of capacitors with dielectric layers containing rare earth elements. One of the more particular objects of the present disclosure is to improve the insulation reliability of capacitors with dielectric layers containing holmium.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

The various inventions disclosed herein may be collectively referred to as “the invention”. An aspect of the present disclosure provides a capacitor including a body, a first external electrode provided on the body, and a second external electrode provided on the body. The body includes a first internal electrode layer, a second internal electrode layer and a dielectric layer. The first external electrode is electrically connected to the first internal electrode layer. The second external electrode is electrically connected to the second internal electrode layer. The dielectric layer is disposed between the first internal electrode layer and the second internal electrode layer. The dielectric layer contains crystal grains of barium titanate. The crystal grains each include a core portion and a shell portion covering the core portion. The shell portion contains Ho, Ni, and Fe. The concentration a, which represents the concentration of Ho in the shell portion, is from 0.5 at % to 5 at %. The concentration b, which represents the concentration of Ni in the shell portion, is from 0.3 at % to 3 at %. The concentration c, which represents the concentration of Fe in the shell portion, is from 0.3 at % to 3 at %.

### ADVANTAGEOUS EFFECTS

According to one embodiment of the disclosure, the insulation reliability of capacitors with dielectric layers containing holmium can be improved.

### BRIEF DESCRIPTION OF THE DRAWINGS

FIG. 1 is a perspective view schematically showing a capacitor according to one embodiment of the disclosure.

FIG. 2 is a sectional view schematically showing a section of the capacitor of FIG. 1 cut along the line I-I.

FIG. 3 is a sectional view schematically showing a section of a crystal grain contained in the dielectric layer of the capacitor shown in FIG. 1.

FIG. 4 is a flowchart showing a flow of a manufacturing method of a capacitor according to one embodiment of the disclosure.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the T axis orthogonal to one another. In this specification, the dimensions, arrangement, shape, and other features of each component of a capacitor 1 may be described with reference to the L, W, and T axes.

### (1) CAPACITOR 1

### (1-1) Basic Structure of Capacitor 1

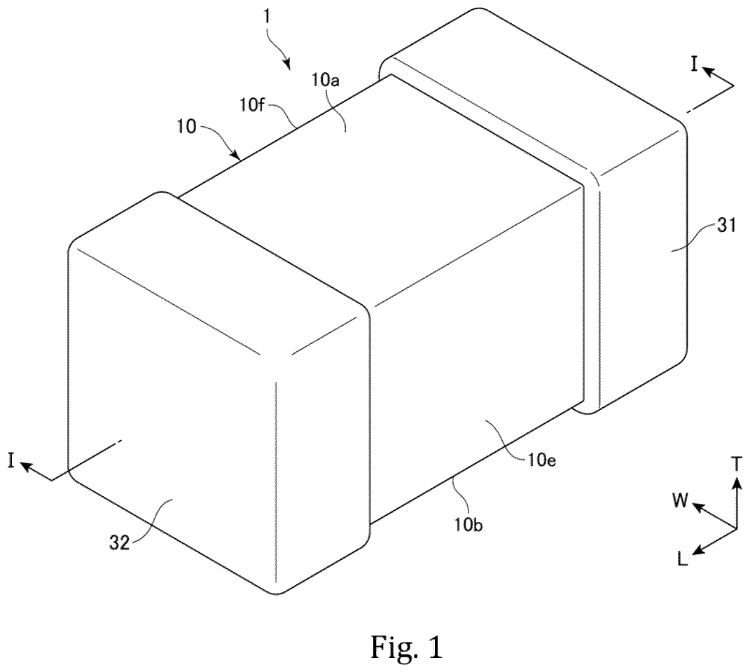

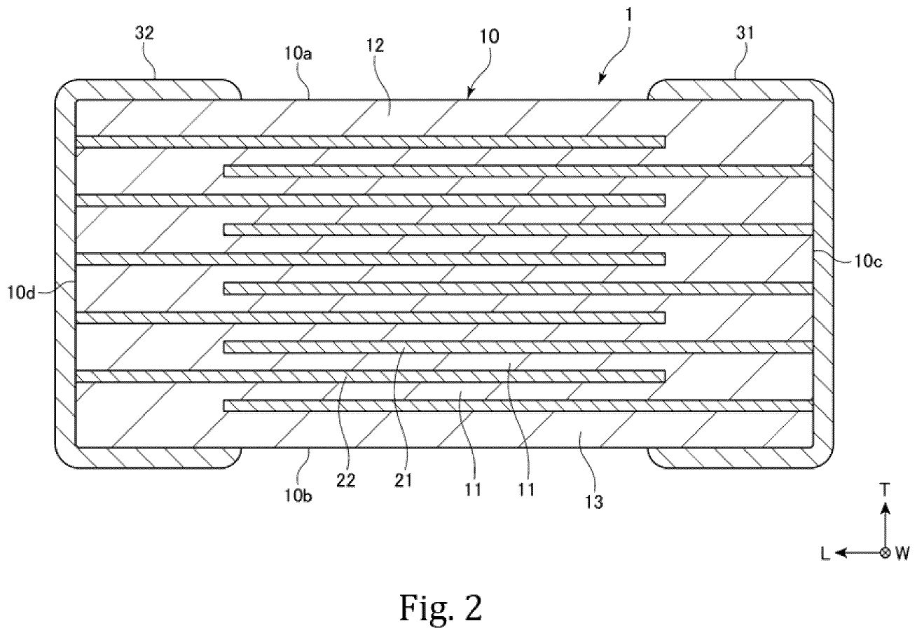

Referring to FIGS. 1 and 2, a description will now be given of the basic structure of a capacitor 1 according to a first embodiment. FIG. 1 is a perspective view showing the capacitor 1 according to the first embodiment. FIG. 2 is a sectional view schematically showing a section of the capacitor 1 cut along the line I-I.

The capacitor 1 has a body 10, and a first external electrode 31 and a second external electrode 32 provided on the body 10. The first external electrode 31 is spaced apart from the second external electrode 32. In the example shown in FIG. 2, the first external electrode 31 is spaced apart from the second external electrode 32 in the L-axis direction.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

The body 10 includes a plurality of dielectric layers 11, a plurality of first internal electrode layers 21, and a plurality of second internal electrode layers 22. A dielectric layer 11 is present between a first internal electrode layer 21 and a second internal electrode layer 22 adjacent to the first internal electrode layer 21. The body 10 is composed of the dielectric layers 11, the first internal electrode layers 21, and the second internal electrode layers 22 stacked together along the lamination direction. In the illustrated embodiment, the dielectric layers 11, the first internal electrode layers 21, and the second internal electrode layers 22 are stacked together along the T-axis direction. The lamination direction may be along the T axis, as shown in the drawings, or may be along the L or W axis. The dielectric layers 11 located at the opposite ends in the lamination direction may be referred to as cover layers.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the embodiment shown in FIG. 2, the first internal electrode layer 21 is led from one end in the L-axis direction toward the outside of the body 10. The first internal electrode layer 21 is connected to the first external electrode 31 at one end of the body 10 in the L-axis direction. The second internal electrode layer 22 is led from the other end in the L-axis direction toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out to the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface. The first and second external electrodes 31 and 32 may be located on any of the surfaces of the body 10 as long as they are separated from each other.

In this specification, the first internal electrode layers 21 and the second internal electrode layers 22 may be referred to collectively as “the internal electrode layers” when it is not necessary to distinguish the first internal electrode layers 21 and the second internal electrode layers 22 from each other.

When voltage is applied between the first and second external electrodes 31 and 32, capacitance is generated between the first and second internal electrode layers 21 and 22.

There may be Fe segregation layers containing Fe provided between the dielectric layers 11 and the first internal electrode layers 21. There may be Fe segregation layers containing Fe provided between the dielectric layers 11 and the second internal electrode layers 22. The Fe segregation layers contain a higher concentration of Fe than the dielectric layers 11 and the inner electrode layers. The Fe segregation layers can enhance the Schottky barrier between the dielectric layers 11 and the inner electrode layers.

The capacitor 1 may be mounted on an electronic circuit board. The electronic circuit board having the capacitor 1 mounted thereon may be referred to as a circuit module. Various electronic components other than the capacitor 1 may also be mounted on the circuit module. The circuit module may be installed in various electronic devices. The electronic devices in which the circuit module can be installed include smartphones, tablets, game consoles, electrical components of automobiles, servers, and various other electronic devices.

In one aspect, the capacitor 1 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the capacitor 1 has a dimension in the L-axis direction (length) of 0.2 mm to 5 mm, a dimension in the W-axis direction (width) of 0.1 mm to 3.5 mm, and a dimension in the T-axis direction (height) of 0.1 mm to 3.0 mm. In one aspect, the length of the capacitor 1 may be larger than the width thereof. In one aspect, the height of the capacitor 1 may be larger than the width thereof. In one aspect, the width of the capacitor 1 may be larger than the length thereof. The capacitor 1 may be configured to have a length of 0.25 mm, a width of 0.125 mm, and a height of 0.125 mm. The capacitor 1 may be configured to have a length of 0.4 mm, a width of 0.2 mm, and a height of 0.2 mm. The capacitor 1 may be configured to have a length of 0.6 mm, a width of 0.3 mm, and a height of 0.3 mm. The capacitor 1 may be configured to have a length of 1.0 mm, a width of 0.5 mm, and a height of 0.5 mm. The capacitor 1 may be configured to have a length of 3.2 mm, a width of 1.6 mm, and a height of 1.6 mm. The capacitor 1 may be configured to have a length of 4.5 mm, a width of 3.2 mm, and a height of 2.5 mm. The dimensions of the capacitor 1 are not limited to those specified herein.

### (1-2) Dielectric Layers 11

### (1-2-1) Composition of Main Component Oxide in Dielectric Layers 11

The dielectric layers 11 contain as their main component an oxide represented by a formula ABO₃. The oxide may have a perovskite structure. The oxide having a perovskite-type structure represented by the chemical formula ABO₃ has A, B, and O sites. The A site is located at the corners of the unit cell. The O site is located at the face centers of the unit cell. The B site is located within an octahedron with the O sites at its corners.

In one aspect, the main component oxide of the dielectric layers 11 is BaTiO₃ (barium titanate), which has a perovskite-type structure. When the main component oxide of the dielectric layers 11 is barium titanate, Ba (barium) occupies the A site, and Ti (titanium) occupies the B site.

The main component oxide of the dielectric layers 11 may be an oxide with a perovskite-type structure that deviates from the stoichiometric composition. In other words, the main component oxide of the dielectric layers 11 does not need to have a 1:1 atomic ratio between the element occupying the A site and the element occupying the B site, as long as the perovskite-type structure can be maintained. The main component oxide of the dielectric layers 11 may have oxygen defects. For example, when the main component oxide of the dielectric layers 11 is represented by the composition formula AαBO₃-β, the values of α and β may fall within the ranges of 0.98≤α≤1.01 and 0≤β≤0.05, respectively.

An Alkali earth metal other than Ba, which can take divalent cations, may occupy the A site of the main component oxide of the dielectric layers 11. Examples of alkaline earth metals that may occupy the A-site include strontium (Sr), calcium (Ca), and magnesium (Mg).

In the main component oxide of the dielectric layers 11, a metal other than Ti that can take a tetravalent cation may occupy the B site. Examples of metals that occupy the B site include hafnium (Hf) and zirconium (Zr).

Examples of the oxides contained in the dielectric layers 11 as a main component include CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y}Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

A component that is at least 50 wt % of the dielectric layers 11 with reference to the total mass of the dielectric layers 11 can be regarded as the main component of the dielectric layers 11. When the dielectric layers 11 contain 50 wt % or more of the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % of the oxide represented by the chemical formula ABO₃.

The dielectric layers 11 may contain one or more additive elements in addition to the main component oxide. In one embodiment, the dielectric layers 11 contains Ho (holmium), Fe (iron), and Ni (nickel).

The dielectric layers 11 may contain first transition elements as additive elements. The first transition elements that can be contained in the dielectric layers 11 include at least one element selected from the group consisting of Co (cobalt), Cu (copper), Zn (zinc), and V (vanadium). The dielectric layers 11 may contain two or more first transition elements.

The dielectric layers 11 may contain second transition elements as additive elements. The second transition elements that can be contained in the dielectric layers 11 include at least one element selected from the group consisting of Y (yttrium), Zr (zirconium), Nb (niobium), Mo (molybdenum), Ru (ruthenium), Rh (rhodium), Pd (palladium), and Ag (silver). The dielectric layers 11 may contain two or more second transition elements.

The dielectric layers 11 may contain third transition elements as additive elements. The third transition elements that can be contained in the dielectric layers 11 include at least one element selected from the group consisting of La (lanthanum), Ce (cerium), Pr (praseodymium), Nd (neodymium), Sm (samarium), Eu (europium), Gd (gadolinium), Tb (terbium), Dy (dysprosium), Er (erbium), Tm (thulium), Yb (ytterbium), Lu (lutetium), Hf (hafnium), Ta (tantalum), W (tungsten), Re (rhenium), Os (osmium), Ir (iridium), Pt (platinum), and Au (gold). The dielectric layers 11 may contain two or more third transition elements.

The dielectric layers 11 may contain oxides of at least one element selected from the group consisting of, for example, Co (cobalt), Ni (nickel), Li (lithium), B (boron), Na (sodium), K (potassium), and Si (silicon). The dielectric layers 11 may contain oxides of two or more of these elements.

The dielectric layers 11 may contain glass containing at least one element selected from the group consisting of Co, Ni, Li, B, Na, K, and Si.

In one aspect, the thickness (the dimension in the T-axis direction) of each dielectric layer 11 is 0.02 to 10 μm. The lower limit for the thickness of the dielectric layer 11 may be either 0.1 μm or 0.2 μm. The upper limit for the thickness of the dielectric layer 11 may be either 3 μm or 1 μm. The cross-section of the capacitor 1 can be observed with an SEM (scanning electron microscope), the thickness of the dielectric layer 11 identified in this cross-section can be measured at 10 points, and the average of the thicknesses measured at these measurement points can be taken as the thickness of the dielectric layer.

### (1-2-2) Crystal Grains

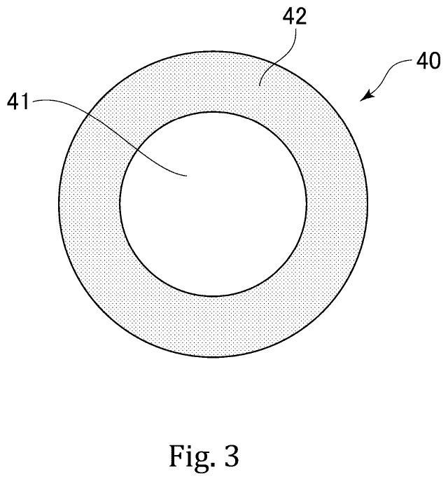

The dielectric layer 11 contains a plurality of crystal grains. At least a part of the plurality of crystal grains has a core-shell structure. FIG. 3 schematically shows a cross-section of a crystal grain having a core-shell structure. As shown in FIG. 3, the crystal grain 40 having a core-shell structure includes a core portion 41 and a shell portion 42 covering the core portion 41. The crystal grain 40 is, for example, a crystal of barium titanate. The elements added to the dielectric layer 11 are dissolved as a solid solution significantly more into the shell portion 42 than into the core portion 41. In other words, the core portion 41 contains no additive elements, or if it does, it contains only trace amounts of them. In one aspect, the shell portion 42 contains Ho, Ni, and Fe. The shell portion 42 may contain the above additive elements in addition to Ho, Ni, and Fe. The insulation property of the dielectric layer 11 is governed by the insulation property of the shell portion 42 rather than the insulation property of the core portion 41. As described below, when the shell portion 42 contains Ho, Ni, and Fe in appropriate proportions, the insulation property of the shell portion 42 can be improved, thereby improving the insulation reliability of the capacitor 1.

It can be confirmed that the dielectric layer 11 includes crystal grains 40 having the core portion 41 and the shell portion 42, as follows. First, a focused ion beam (FIB) system is used to take a sliced analysis sample with a thickness of 50 to 80 nm from the capacitor 1. In an observation surface of the analysis sample, an observation field within the dielectric layer 11 is observed with a scanning transmission electron microscope (STEM) equipped with either an energy dispersive X-ray spectrometer (EDS) or a wavelength dispersive X-ray spectrometer (WDS) at a magnification of 10,000 to 150,000, to obtain a mapping image of the quantified elements. If the dielectric layer 11 contains Ho, Ni, and Fe, these elements can be the quantified elements. The core portion 41 and the shell portion 42 can be identified by contrast differences in the mapping image obtained by STEM-EDS. As described above, the additive elements such as Ho, Ni, and Fe are dissolved as a solid solution significantly more into the shell portion 42 than into the core portion 41, and thus the region in the observation field where a large amount of these additive elements are detected can be identified as the shell portion 42. The region surrounded by the shell portion 42, identified in this way, can be identified as the core portion 41. The TEM may be JEM-2100F from JEOL Ltd. The EDS may be DrySD100GV detector from JEOL Ltd.

When using a STEM, the observation surface of the analysis sample may be observed by a high-angle annular dark-field scanning transmission electron microscopy image (HAADF-STEM image). In the HAADF-STEM image, the shell portion 42 is observed as a region having a higher brightness than the core portion 41.

In one aspect, in the cross section shown in FIG. 3, the area proportion of the core portion 41 to the total area of the crystal grain 40 is 20% to 95%. The proportion of the area of the core portion 41 to the total area of the crystal grain 40 is preferably 40% to 85%, and more preferably 60% to 80%. As the content of the additive elements in the dielectric layer 11 increases, the area of the shell portion 42 increases. The proportion of the area of the core portion 41 to the total area of the crystal grain 40 can be calculated by counting, in the above mapping image obtained by STEM-EDS, the number of pixels in the region corresponding to the crystal grain 40 and the number of pixels in the region corresponding to the core portion 41, and dividing the number of pixels in the region corresponding to the core portion 41 by the number of pixels in the region corresponding to the crystal grain 40.

### (1-2-3) Concentration of Additive Elements in Shell Portion 42

The following describes the concentration of the additive elements in the shell portion 42. In this specification, unless otherwise explained or unless the context requires otherwise, the concentration of a certain additive element contained in the dielectric layers 11 refers to the atomic percentage (at %) of that element, assuming that the total of the elements in the main component oxide of the dielectric layers 11 is 100 at %. For example, if the main component oxide in the dielectric layers 11 is barium titanate (BaTiO₃), the concentration of an additive element refers to the atomic percentage (at %) of that element, assuming that the total of the elements in the barium titanate (i.e., Ba, Ti, and O) is 100 at %.

The concentration of the additive elements in the shell portion 42 can be determined by the following procedure.
(1) First, a focused ion beam (FIB) system is used to take a sliced analysis sample with a thickness of 50 to 80 nm from the capacitor 1.
(2) Next, a scanning transmission electron microscope (STEM) equipped with either an energy dispersive X-ray spectrometer (EDS) or a wavelength dispersive X-ray spectrometer (WDS) is used to obtain a HAADF-STEM image of an observation surface. In the HAADF-STEM image, a region that appears bright and surrounds a region appearing dark is identified as the shell portion 42.
(3) Next, the type and concentration of the elements contained in any location within the shell portion 42 are determined using EDS or WDS. For the measurement, the acceleration voltage can be set to 200 kV, the electron beam diameter to 1.5 nm, and the measurement time to 2 hours. For quantitative evaluation of Ba, the intensity of the Ba K-line or L-line can be used. For quantitative evaluation of Ti, the intensity of the Ti K-line can be used. For quantitative evaluation of Ho, the intensity of the Ho L-line can be used. For quantitative evaluation of Ni, the intensity of the Ni K-line can be used. For quantitative evaluation of Fe, the intensity of the Fe K-line can be used. In quantitative evaluation, the content of each element can be calculated by applying corrections—such as ZAF correction—that take into account atomic number effects, absorption effects, and fluorescence excitation effects to the spectra of the Ba K-line or L-line, Ti K-line, Ho L-line, Ni K-line, and Fe K-line. When the sample is sufficiently thin, for example with a thickness of several tens of nanometers or less, the concentration of each element may be calculated in quantitative evaluation by correcting the spectrum of each element using the proportionality coefficients (K-factors) employed in the Cliff-Lorimer method. In addition to the correction used in the Cliff-Lorimer method, a correction that takes into account the absorption effect of the sample may be performed to calculate the concentration of each element. The absorption effect of the sample can be determined by determining the thickness and density of the sample. The thickness of the sample can be determined, for example, by acquiring convergent-beam electron diffraction (CBED) diagrams under two-wave excitation conditions and analyzing the rocking curve observed on the diffraction disk. For example, the main phase crystalline particle 4 can be used as the particle for acquiring the CBED diagram. The density of the sample may be, for example, 6.02 g/cm³, the density of barium titanate. In EDS measurements, the proximity of the energy peaks of the Ba Lα line and the Ti Kα line can make it difficult to quantify Ba and Ti. Therefore, it is desirable to perform EDS measurements so that the Ba Lβ2 line and LIIIab line are obtained with sufficient intensity. Specifically, it is desirable to perform the measurement such that the intensity at the peaks of the Ba Lβ2 line and LIIIab line is 10,000 counts or more. If the intensity at the peaks of the Ba Lβ2 line and LIIIab line is 10,000 counts or more, the characteristic X-ray intensity of Ba can be identified, allowing the Ba content to be calculated. Once the Ba content is calculated, even if the Ba Lα line and the Ti Kα line overlap, the intensity of the Ti Kα line can be identified, making it possible to calculate the Ti content as well.
(4) The concentration of the additive element may be measured at multiple locations in the shell portion 42 according to the method described in (3), and the average of the concentrations measured at those multiple locations may be used as the concentration of that additive element in the shell portion 42. The multiple measurement points in the shell portion 42 should be evenly distributed within the shell portion 42. For example, eight measurement points may be set at 45° intervals in the circumferential direction, and the average of the concentrations of the additive element at these eight points can be used as the concentration of the element in the shell portion 42. Instead of the average value, the median value of the concentrations of the additive element measured at multiple locations in the shell portion 42 may be used as the concentration of the additive element in the shell portion 42. The concentration of the additive element may be measured throughout the entire region of the shell portion 42, and the average value or the median value of the concentration may be used as the concentration of that additive element in the shell portion 42.

The concentration of additive elements in the core portion 41 can be measured in the same manner as in the shell portion 42. The concentration of the additive element in the core portion 41 may be determined by measuring the concentration of the additive element at multiple locations within the core portion 41 and using the average of those values measured at the multiple locations as the concentration of that additive element in the core portion 41. Instead of the average value, the median value of the concentrations of the additive element measured at multiple locations in the core portion 41 may be used as the concentration of the additive element in the core portion 41. The concentration of the additive element may be measured throughout the entire region of the core portion 41, and the average value or the median value of the concentration may be used as the concentration of that additive element in the core portion 41.

When the thinned analysis sample is taken from the capacitor 1, there is a possibility that Ni contained in the internal electrode layer may be mixed into the observation surface of the dielectric layer 11. Therefore, the concentration of Ni quantified by EDS measurement on the analysis sample may be the sum of the Ni that was dissolved as a solid solution into the shell portion 42 during the manufacturing of the capacitor 1 and the Ni that was mixed into the shell portion 42 when the analysis sample was taken from capacitor 1. Therefore, when quantifying the Ni concentration in the shell portion 42 by the EDS measurement, it is desirable to employ a method that can quantify the concentration of Ni dissolved as a solid solution into the shell portion 42 during the manufacturing of the capacitor 1 by removing the effect of Ni that was mixed into the shell portion 42 when the analysis sample was taken from the capacitor 1. For example, when the analysis sample is taken out, Ni in the inner electrode layer is mixed into the core portion 41 and the shell portion 42 to the same extent, whereas during the manufacturing of the capacitor 1, the amount of Ni dissolved as a solid solution into the core portion 41 is significantly smaller than that of Ni dissolved as a solid solution into the shell portion 42. Therefore, the Ni concentration in the shell portion 42 can be approximated by subtracting the Ni concentration in the core portion 41 from the Ni concentration in the shell portion 42, both measured by EDS measurement. Since this approximation is calculated by subtracting the concentration of Ni in the core portion 41 from the concentration of Ni in the shell portion 42, the effect of Ni mixed into the core portion 41 and the shell portion 42 during the preparation of the analysis sample is removed from this approximation.

When quantifying Fe in the EDS measurement, since Fe is used in the objective lens component (pole piece) of the STEM, the concentration of Fe measured by EDS includes system noise caused by the Fe used in this objective lens. Therefore, when quantifying the Fe concentration in the shell portion 42 by the EDS measurement, it is desirable to employ a method that can quantify the concentration of Fe dissolved as a solid solution into the shell portion 42 during the manufacturing of the capacitor 1 by removing the effect of the system noise. For example, the system noise is included in the Fe concentration quantified in the core portion 41 and the Fe concentration quantified in the shell portion 42 to the same extent, whereas during the manufacturing of the capacitor 1, the amount of Fe dissolved as a solid solution into the core portion 41 is significantly smaller than that of Fe dissolved as a solid solution into the shell portion 42. Therefore, the Fe concentration in the shell portion 42 can be approximated by subtracting the Fe concentration in the core portion 41 from the Fe concentration in the shell portion 42, both measured by EDS measurement. Since this approximation is calculated by subtracting the concentration of Fe in the core portion 41 from the concentration of Fe in the shell portion 42, the effect of system noise is removed from this approximation.

During the manufacturing of the capacitor 1, the amount of Ho dissolved as a solid solution into the core portion 41 is significantly smaller than that of Ho dissolved as a solid solution into the shell portion 42. Therefore, as in the methods of quantifying Ni and Fe, the Ho concentration in the shell portion 42 can be approximated by subtracting the Ho concentration in the core portion 41 from the Ho concentration in the shell portion 42, both measured by EDS measurement.

In one aspect, the concentration of Ho contained in the shell portion 42 (concentration a) is from 0.5 at % to 5 at %, based on a total of 100 at % for the constituent elements of barium titanate (BaTiO₃), namely Ba, Ti, and O. In one aspect, the concentration a is from 1.5 at % to 3.5 at %. The concentration a may be quantified by EDS measurement in the shell portion 42. The concentration a may be expressed as an approximation represented by the difference between the concentration of Ho in the shell portion 42 quantified by EDS measurement and the concentration of Ho in the core portion 41 quantified by EDS measurement.

In the shell portion 42, dissolving Ho as a solid solution into the A site can inhibit the migration of oxygen defects, thereby enhancing the insulation reliability of the capacitor 1. On the other hand, if an excess amount of Ho is dissolved as a solid solution into the shell portion 42, Ho will dissolve as a solid solution into the B site, causing oxygen defects in the barium titanate in the shell portion 42. Thus, excess addition of Ho will also cause a decrease in the reliability of the shell portion 42. Therefore, the concentration of Ho in the shell portion 42 should be sufficient to inhibit the migration of oxygen defects, while at the same time, it should be within the range that allows inhibition of the decrease in the insulation reliability of the capacitor 1 due to the increased concentration of oxygen defects in the dielectric layers 11.

As described above, mere presence of Ho in the shell portion 42 results in a partial offset of the improvement in insulation reliability of the capacitor 1—achieved by the solid solution of Ho into barium titanate—by a decrease in insulation reliability of the capacitor 1 due to an increase in oxygen defect concentration caused by Ho. Therefore, it is difficult to sufficiently improve the insulation reliability of the capacitor 1 solely by adjusting the concentration of Ho in the shell portion 42.

The inventor noted that the presence of Ni and Fe as well as Ho in the shell portion 42 can inhibit the occurrence of oxygen defects due to Ho. Ho can be dissolved as a solid solution into both the A and B sites of barium titanate, while Ni and Fe can be dissolved as a solid solution into the B site (Ti site) of barium titanate. The oxygen defects in barium titanate due to Ho are primarily caused by Ho dissolved as a solid solution into the B site, not Ho dissolved as a solid solution into the A site. The solid solution of Ni and Fe into the B site of barium titanate inhibits the solid solution of Ho into the B site and promotes the solid solution of Ho into the A site. Ho dissolved as a solid solution into the A site is less likely to produce oxygen defects in barium titanate than Ho dissolved as a solid solution into the B site. Therefore, dissolving Ni and Fe, as well as Ho, as a solid solution into the shell portion 42 can inhibit the occurrence of oxygen defects due to Ho, thereby further enhancing the insulation reliability of the capacitor 1.

In addition, Ni and Fe, which can be dissolved as a solid solution into the B site of barium titanate, also serve to improve the insulation reliability of the capacitor 1. For example, Ni inhibits the reduction of barium titanate in the firing process for manufacturing the capacitor 1, thus improving the insulation reliability of the capacitor 1. On the other hand, after firing, Ni is dissolved as a solid solution into barium titanate, producing oxygen defects in the barium titanate within the shell portion 42. Therefore, when the concentration of Ni in the shell portion 42 is high, the improvement in insulation reliability of the capacitor 1—achieved by inhibiting the reduction of barium titanate during firing—is partially offset by a decrease in insulation reliability caused by an increase in oxygen defect concentration after firing. For this reason, the presence of an excess amount of Ni in the shell portion 42 is not desirable. Therefore, the concentration of Ni in the shell portion 42 should be sufficient to inhibit the solid solution of Ho into the B site, while at the same time, it should be within the range that allows inhibition of the decrease in the insulation reliability of the capacitor 1 due to the increased concentration of oxygen defects in the dielectric layers 11.

Since Ni is contained in the precursor of the inner electrode layers and the precursor of the dielectric layers 11, it is thermally diffused during firing and is dissolved as a solid solution into barium titanate upon completion of the firing process. Since Fe diffuses thermally even at lower temperatures than Ni, when the precursor of the body 10 is heated during the manufacturing of the capacitor 1, Fe diffuses into the precursor of the dielectric layers 11 prior to Ni and inhibits diffusion of Ni into the precursor of the dielectric layers 11. After firing, Fe is dissolved as a solid solution into barium titanate within the shell portion 42. If a re-oxidation process (oxidation process performed after firing) is performed in the manufacturing process of the capacitor 1, the presence of Fe in the shell portion 42 can reduce the oxygen defect concentration in the shell portion 42. With Fe added to the raw material and thus contained in the shell portion 42, the solid solution of Ni into the barium titanate within the shell portion 42 can be inhibited, so as to inhibit the occurrence of oxygen defects, and the solid solution of Fe into the barium titanate within the shell portion 42 improves the insulation reliability of the capacitor 1.

As the concentration of Fe in the dielectric layers 11 increases, the electron concentration in the dielectric layers 11 increases accordingly. Thus, an excessive concentration of Fe in the dielectric layers 11 decreases the insulation reliability of the capacitor 1. Therefore, the concentration of Fe in the shell portion 42 should be sufficient to inhibit the solid solution of Ho into the B site and inhibit diffusion of Ni, while at the same time, it should be within the range that allows inhibition of the decrease in the insulation reliability of the capacitor 1 due to the increased electron concentration in the dielectric layers 11.

Considering the effects of Ho, Ni, and Fe on the insulation reliability of the capacitor 1 as described above, Ho, Ni, and Fe should be contained in the shell portion 42 as follows.

In one aspect, the concentration of Ni contained in the shell portion 42 (concentration b) is from 0.3 at % to 3 at %, based on a total of 100 at % for the constituent elements of barium titanate (BaTiO₃), namely Ba, Ti, and O. In one aspect, the concentration b is from 1 at % to 2.5 at %. The concentration b may be expressed as an approximation represented by the difference between the concentration of Ni in the shell portion 42 and the concentration of Ni in the core portion 41.

In one aspect, the concentration of Fe contained in the shell portion 42 (concentration c) is from 0.3 at % to 3 at %, based on a total of 100 at % for the constituent elements of barium titanate (BaTiO₃), namely Ba, Ti, and O. In one aspect, the concentration c is from 1 at % to 2.5 at %. The concentration c may be expressed as an approximation represented by the difference between the concentration of Fe in the shell portion 42 and the concentration of Fe in the core portion 41.

In one aspect, the ratio of the sum of the concentration b and the concentration c to the concentration a ((concentration b+concentration c)/concentration a) is less than or equal to 2.

In one aspect, the ratio of the concentration c to the concentration b (concentration c/concentration b) is greater than or equal to 0.1. In one aspect, the ratio of the concentration c to the concentration b (concentration c/concentration b) is greater than or equal to 0.15.

### (1-3) First Internal Electrode Layers 21 and Second Internal Electrode Layers 22

In one aspect, the first internal electrode layers 21 contain a base metal such as Ni (nickel), Cu (copper), and Sn (tin), as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more the base metal as the main component thereof. The first internal electrode layers 21 can contain Fe in addition to the main component metal.

The first internal electrode layers 21 can contain additive metal elements in addition to the main component metal and Fe. The additive metal elements that can be contained in the first internal electrode layers 21 are, for example, metals that are more noble than the main component metal of the first internal electrode layers 21. The additive metal elements that can be contained in the first internal electrode layers 21 are one or more elements selected from the group consisting of, for example, Au, Sn, Cr, Y, In (indium), As (arsenic), Co, Cu, Ir (iridium), Mg, Os (osmium), Pd, Pt, Re (rhenium), Rh (rhodium), Ru (ruthenium), Se (selenium), Te (tellurium), W and Zn (zinc).

The description of the components of the first internal electrode layers 21 also applies to the components of the second internal electrode layers 22.

### (1-4) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag (silver), Pd (palladium), Au (gold), Pt (platinum), Ni (nickel), Sn (tin), Cu (copper), W (tungsten), Ti (titanium), and alloys of these.

### (2) MANUFACTURING METHOD OF CAPACITOR 1

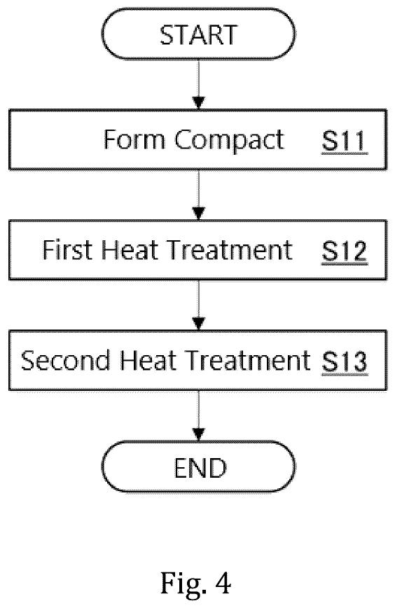

A description will now be given of one example of the manufacturing method of the capacitor 1 with reference to FIG. 4. FIG. 4 is a flowchart showing a flow of a manufacturing method of a capacitor according to one embodiment of the disclosure.

Here is a brief description of the manufacturing method shown in FIG. 4. In step S11, a compact as the precursor of the body 10 is formed. The compact includes dielectric green sheets, which are the precursor of the dielectric layers 11, and internal electrode patterns, which are the precursor of the internal electrode layers (the first and second internal electrode layers 21 and 22). The compact may be formed by alternately stacking dielectric green sheets each having an internal electrode pattern on the surface thereof which is the precursor of the first internal electrode layer 21, and dielectric green sheets each having an internal electrode pattern on the surface thereof which is the precursor of the second internal electrode layer 22. The dielectric green sheets contain Ho. The internal electrode patterns contain Ni. At least one of the dielectric green sheets or the internal electrode patterns contains Fe. Next, in step S12, the compact formed in step S11 is subjected to the first heat treatment at the first temperature in a low oxygen concentration atmosphere to diffuse Fe in the dielectric green sheet. In step S13, the compact having undergone the first heat treatment is heated at a second temperature higher than the first temperature to fire the dielectric green sheets and the internal electrode patterns, so as to obtain the capacitor 1.

The following describes, in more detail, each of the steps of the manufacturing method according to one embodiment with reference to FIG. 4. First, in the step S11, raw powder containing dielectric powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain a dielectric green sheet. The dielectric green sheets are the precursor of the dielectric layers 11.

The dielectric powder is, for example, barium titanate (BaTiO₃) powder. Barium titanate powder is synthesized by reacting titanium raw material such as titanium dioxide with barium raw material such as barium carbonate by a known method such as the solid phase method, the sol-gel method, or the hydrothermal method.

The raw powder of the dielectric green sheets may be a mixed powder, which is a mixture of the dielectric powder and additive powder. The additives added to the dielectric powder are, for example, Ho and Fe. The mixed powder is produced by mixing the dielectric powder with Ho₂O₃powder and Fe₂O₃powder. The mixed powder may be produced, for example, by mixing 0.350 to 1.000 mol of holmium oxide (Ho₂O₃) powder and 0.050 to 1.000 mol of ferric oxide (Fe₂O₃) powder with 100 mol of BaTiO₃ powder. In order to produce the mixed powder, at least one of magnetite (Fe₃O₄) powder and iron oxyhydroxide (FeOOH) powder may be mixed with BaTiO₃, in place of or in addition to ferric oxide (Fe₂O₃) powder.

Next, an internal electrode pattern is formed on each of the dielectric green sheets formed as described above. The internal electrode pattern is formed, for example, by printing a paste for the internal electrodes on the dielectric green sheet using screen printing or other known printing methods. When the internal electrode patterns are formed by screen printing, the paste for the internal electrodes is produced by kneading and mixing a metal powder, a binder resin, and a solvent by a three-roll mill. In other words, the paste for the internal electrodes is produced by dispersing a metal powder in a binder resin. The metal powder contained in the paste for the internal electrodes includes powder of Ni, which is the main component of the first and second internal electrode layers 21 and 22. The metal powder contained in the paste for the internal electrodes may be a mixture of Ni powder and powder of a base metal other than Ni (e.g., Cu or Sn). The metal powder contained in the paste for the inner electrodes may be a mixture of Ni powder and Fe₂O₃ powder. The dielectric powder contained in the dielectric green sheets may be added to the paste for the internal electrodes. The organic binder used in the paste for the internal electrodes may be a cellulose-based resin such as ethyl cellulose or an acrylic resin such as butyl methacrylate. The internal electrode patterns formed on some of the dielectric green sheets are the precursor of the first internal electrode layers 21, and the internal electrode patterns formed on the others of the dielectric green sheets are the precursor of the second internal electrode layers 22.

The internal electrode patterns may be formed on the dielectric green sheets by the sputtering method. The method of forming the internal electrode patterns is not limited to that specified herein. The internal electrode patterns may be formed by various known methods, e.g., vacuum deposition, PLD (pulsed laser deposition), MO-CVD (metal organic chemical vapor deposition), MOD (metal organic decomposition), or CSD (chemical solution deposition).

When forming the internal electrode patterns by the sputtering method, a conductor target containing Ni is sputtered under predetermined film-forming conditions, and the sputtered particles generated at this time are deposited on the dielectric green sheets. The conductor target may contain Fe as well as base metals.

Both the dielectric green sheet and the internal electrode pattern may contain Fe, or only one of the dielectric green sheet and the internal electrode pattern may contain Fe.

Additive elements other than Ho, Ni, and Fe may be added to at least one of the dielectric green sheet and the internal electrode pattern.

Next, the dielectric green sheet with an internal electrode pattern formed on the surface thereof is removed from the substrate film. The dielectric green sheets each having an internal electrode pattern formed on the surface thereof are prepared in this way, and a predetermined number (e.g., 100 to 1000) of such dielectric green sheets are stacked and thermocompressed to obtain a laminate. The top layer and the bottom layer of the laminate may be formed of dielectric green sheets that do not have internal electrode patterns formed thereon. The dielectric green sheet at the top of the laminate is the precursor of the upper cover layer 12, and the dielectric green sheet at the bottom of the laminate is the precursor of the lower cover layer 13.

Next, the laminate is diced into pieces to obtain chip compacts each being the precursor of the body 10. The chip compacts may be subjected to a degreasing process. The degreasing process may be performed in an N₂ atmosphere. The compacts having undergone the degreasing process may be coated with a metal paste by the dip method to form base layers for the first and second external electrodes 31 and 32.

Next, in step S12, the chip compact produced in step S11 is subjected to the first heat treatment. Specifically, the first heat treatment is performed according to the following heating conditions.
Atmosphere: low oxygen atmosphere (oxygen partial pressure of 10⁻⁹ to 10⁻¹⁰ atm)
First heating temperature: 1000 to 1150° C.
Heating time: 10 minutes to 1 hour

The first heat treatment is performed as a pre-process of the firing process (second heat treatment) to promote thermal diffusion of Fe. In the first heat treatment, the compact is heated in an atmosphere with a higher oxygen partial pressure than in the second heat treatment described below for a sufficient time (10 minutes to 1 hour) to allow Fe to diffuse within the compact, and therefore, Fe can diffuse within the compact, without alloying with Ni.

If the internal electrode patterns in the compact contain Fe, the first heat treatment can cause Fe in the internal electrode patterns to thermally diffuse toward the interfaces with the dielectric green sheets, forming Fe segregation layers containing much Fe at the interfaces between the internal electrode patterns and the dielectric green sheets.

Next, in step S13, the compact having undergone the first heat treatment in step S12 is subjected to the second heat treatment at a second heating temperature higher than the first heating temperature to fire the compact, so as to obtain the capacitor 1. Through the second heat treatment, the dielectric green sheets in the compact are fired to form the dielectric layers 11, the upper cover layer 12, and the lower cover layer 13, the internal electrode patterns are fired to form the first internal electrode layers 21 and the second internal electrode layers 22, and the base layer of the metal paste formed on the surface of the compact form the first external electrode 31 and the second external electrode 32.

The second heat treatment on the compact is performed according to the following heating conditions.
Atmosphere: low oxygen atmosphere (oxygen partial pressure of 10⁻¹⁰ to 10⁻¹² atm)
Second heating temperature: 1100 to 1300° C.
Heating time: 10 minutes to 1 hour

In the second heat treatment, the compact is heated at a high temperature of about 1100 to 1300° C., which causes thermal diffusion of Ni contained in the internal electrode patterns. However, since Fe is thermally diffused in the dielectric green sheets in the first heat treatment, Fe thermally diffused in the dielectric green sheets inhibits the thermal diffusion of Ni from the internal electrode patterns to the dielectric green sheets.

In the second heat treatment, the temperature should desirably be increased at a high rate to the above heating temperature. The temperature increase rate in the second heat treatment is, for example, 5,000° C./h to 10,000° C./h.

Processes not shown in the flowchart of FIG. 4 may be performed to produce the capacitor 1. For example, the capacitor 1 obtained through the second heat treatment in step S12 may be subjected to re-oxidation treatment at 600° C. to 1000° C. in an N₂ gas atmosphere. A plating layer of Cu, Ni, Sn or the like may be provided on the surfaces of the first and second external electrodes 31 and 32. This plating layer can be formed by the electrolytic or electroless plating method.

### (3) EXAMPLES

The invention will now be further described in detail based on examples. The invention is not limited to the following examples.

First, 19 different samples were prepared according to the manufacturing method shown in FIG. 4, as follows. To prepare the samples, BaTiO₃ powder as the main component oxide of the dielectric layers 11, and Ho₂O₃ powder and Fe₂O₃ powder as the additives were prepared. Then, the Ho₂O₃ powder and Fe₂O₃ powder were weighed so that their molar ratios relative to 100 mol of BaTiO₃ powder would be as shown in Table 1 below. The amount of Ho₂O₃ powder added is shown in the column “Ho₂O₃ (mol)”, and the amount of Fe₂O₃ powder added is shown in the column “Fe₂O₃ (mol)”. These weighed powders were mixed and ground using zirconia beads having a diameter of 1 mm, to obtain the raw powder for the dielectric green sheets corresponding to samples 1 to 19.

Next, for each of the raw powders for the dielectric green sheets used to prepare samples 1 to 19, polyvinyl butyral (PVB) resin, a solvent, and a plasticizer were added and wet-mixed to obtain 19 different slurries for dielectric green sheets. Each of these slurries was coated on a substrate film, and then the slurry coated on the substrate film was dried to obtain 19 types of dielectric green sheets.

Next, Ni powder was wet-mixed with polyvinyl butyral (PVB) resin, a solvent, and a plasticizer to obtain a slurry for the internal electrodes. Then, the slurry for the internal electrodes was printed on each dielectric green sheet, to form an internal electrode pattern on the dielectric green sheet. In this way, 19 types of dielectric green sheets each having the internal electrode pattern on the surface thereof were obtained.

Next, 500 dielectric green sheets for each of samples 1 to 19 were stacked together to form a laminate, which was then diced into chip compacts. The chip compacts had the 1005 shape (length: 1.0 mm, width: 0.5 mm, height: 0.5 mm). Next, these chip compacts were degreased in an N₂ atmosphere. Following this, metal paste was applied to the degreased compacts by the dip method, to form base layers of the external electrodes on the compacts.

Next, each of the 19 types of chip compacts obtained as described above was subjected to the first heat treatment at 1000° C. for 30 minutes in a low-oxygen atmosphere with an oxygen partial pressure of 10⁻⁹ to 10⁻¹⁰ atm.

Next, each of the 19 types of compacts having undergone the first heat treatment was heated with the temperature increased to 1200° C. at 6000° C./h and heated at 1200° C. for 30 minutes in a low-oxygen atmosphere with an oxygen partial pressure of 10⁻¹⁰ to 10⁻¹² atm.

Samples 1 to 19 were prepared in this manner. In samples 1 to 19, the dielectric green sheets were fired to form the dielectric layers, and the internal electrode patterns were fired to form the internal electrode layers. The base layers formed on the compacts were fired to form the external electrodes. Therefore, samples 1 to 19 are all capacitors in which the dielectric layers and internal electrode layers are arranged alternately along the T-axis direction.

Next, each of samples 1 to 19 was sliced using a focused ion beam (FIB) system so that the LT surface (FIG. 2) can be the observation surface, and a sliced analysis sample with a thickness of 60 nm was taken from each of samples 1 to 19. Damage that appeared on the observation surfaces of the sliced samples was removed as appropriate by Ar ion milling.

Next, each of the sliced samples was placed in a TEM equipped with an EDS detector, and a STEM image was acquired on the observation surface of the sliced sample. The contrast difference in the STEM image was used to identify the dielectric layers. The TEM was JEM-2100F from JEOL Ltd. The EDS detector was the DrySD100GV detector from JEOL Ltd. Next, ten locations within the dielectric layer on the observation surface of the analysis sample were each observed at a magnification of 100,000. In each of the ten observation regions, a HAADF-STEM image was obtained. In the HAADF-STEM image, a region that appears bright and surrounds a region appearing dark was identified as the shell portion of a dielectric crystal grain.

Next, for each of the ten observation regions, the types and concentrations of the elements contained in the shell portion and the core portion were determined by measurement using EDS. During the measurement, the acceleration voltage was 200 kV, the electron beam diameter was 1.0 nm, and the measurement time was 3 hours, and the concentrations of Ba, Ti, O, Ho, Ni, and Fe were measured in the entire region within the shell portion and in the entire region within the core portion. For the quantitative evaluation, the concentration of each element was calculated by applying the Zaf correction to the K-line or L-line spectrum of Ba, the K-line spectrum of Ti, the L-line spectrum of Ho, the K-line spectrum of Ni, and the K-line spectrum of Fe.

Based on the concentration of each element obtained by EDS measurement, the concentrations (at %) of Ho, Ni, and Fe in each of the shell portion and the core portion were calculated, assuming that the total of Ba, Ti, and O was 100 at %. The value obtained by subtracting the concentration of Ho in the core portion from the concentration of Ho in the shell portion, both calculated as described above, is shown in Table 1 below as the measured concentration of Ho in the shell portion. Similarly, the value obtained by subtracting the concentration of Ni in the core portion from the concentration of Ni in the shell portion, both calculated as described above, is shown in Table 1 below as the measured concentration of Ni in the shell portion, and the value obtained by subtracting the concentration of Fe in the core portion from the concentration of Fe in the shell portion, both calculated as described above, is shown in Table 1 below as the measured concentration of Fe in the shell portion. The concentrations of Ho, Ni, and Fe in the shell portion are shown in the columns “Ho (at %)”, “Ni (at %)”, and “Fe (at %)”, respectively. In Table 1, the column “(Ni+Fe)/Ho” shows the ratio of the sum of the concentration of Ni and the concentration of Fe in the shell portion to the concentration of Ho in the shell portion. In Table 1, the column “Fe/Ni” shows the ratio of the concentration of Fe in the shell portion to the concentration of Ni in the shell portion.

Next, ten samples were selected for each of samples 1 to 19, and an accelerated life test (HALT) was performed on each of these selected samples. In the accelerated life test, for each of samples 1 to 19, the life of each of the ten selected samples was determined while a voltage of 30 V/μm was applied under 150° C., and the average failure time was calculated by averaging the lives determined for these ten samples. The average failure time for each sample calculated in this way is shown in the column “HALT MTTF (min)” of Table 1.

In Table 1, the samples not encompassed by the present invention (i.e., comparative examples) have an asterisk (*) added to the sample number. Specifically, samples 12 to 19 are comparative examples not encompassed by the present invention.

TABLE 1

| | | | | | | | | HALT |
|---|---|---|---|---|---|---|---|---|
| Sample | Ho₂O₃ | Fe₂O₃ | Ho | Ni | Fe | | | MTFF |
| No. | (mol) | (mol) | (at %) | (at %) | (at %) | (Ni + Fe)/Ho | Fe/Ni | (min) |
| Sample 1 | 0.750 | 0.050 | 3.00 | 2.60 | 0.35 | 0.98 | 0.13 | 1550 |
| Sample 2 | 0.750 | 0.100 | 2.75 | 2.40 | 0.45 | 1.04 | 0.19 | 1725 |
| Sample 3 | 0.750 | 0.200 | 3.05 | 2.20 | 0.65 | 0.93 | 0.30 | 2490 |
| Sample 4 | 0.750 | 0.300 | 3.10 | 1.70 | 0.90 | 0.84 | 0.53 | 3615 |
| Sample 5 | 0.750 | 0.500 | 2.40 | 1.25 | 1.15 | 1.00 | 0.92 | 3110 |
| Sample 6 | 0.750 | 0.750 | 3.25 | 0.70 | 2.10 | 0.86 | 3.00 | 2500 |
| Sample 7 | 0.750 | 1.000 | 3.15 | 0.40 | 2.85 | 1.03 | 7.13 | 1670 |
| Sample 8 | 0.375 | 0.200 | 0.55 | 0.70 | 0.35 | 1.91 | 0.50 | 1150 |
| Sample 9 | 0.500 | 0.200 | 1.75 | 1.55 | 0.45 | 1.14 | 0.29 | 1990 |
| Sample 10 | 0.900 | 0.200 | 4.20 | 2.60 | 0.50 | 0.74 | 0.19 | 2140 |
| Sample 11 | 1.000 | 0.200 | 4.85 | 2.95 | 0.55 | 0.72 | 0.19 | 1840 |
| Sample 12 * | 1.000 | 0.000 | 3.90 | 3.20 | 0.30 | 0.90 | 0.09 | 635 |
| Sample 13 * | 0.750 | 0.000 | 2.60 | 2.10 | 0.28 | 0.92 | 0.13 | 635 |
| Sample 14 * | 0.500 | 1.000 | 1.90 | 0.28 | 2.55 | 1.49 | 9.11 | 820 |
| Sample 15 * | 0.750 | 1.250 | 3.70 | 0.35 | 3.05 | 0.92 | 8.71 | 250 |
| Sample 16* | 0.275 | 0.200 | 0.45 | 0.50 | 0.35 | 1.89 | 0.70 | 305 |
| Sample 17 * | 0.300 | 0.100 | 0.55 | 0.85 | 0.30 | 2.09 | 0.35 | 305 |
| Sample 18 * | 1.000 | 0.050 | 4.45 | 3.05 | 0.35 | 0.76 | 0.11 | 250 |
| Sample 19 * | 1.250 | 0.200 | 5.15 | 2.80 | 0.40 | 0.62 | 0.14 | 460 |

In samples 1 to 11 (examples), the average failure time is 1150 hours or more, which is longer than the average failure time (250 to 820 hours) in samples 12 to 19 as comparative examples.

In samples 1 to 11, the concentration of Ho in the shell portion is in the range of 0.5 at % to 5 at %, the concentration of Ni in the shell portion is in the range of 0.3 at % to 3 at %, and the concentration of Fe in the shell portion is in the range of 0.3 at % to 3 at %. In these samples, Ho contained in the shell portion at a concentration of 0.5 at % to 5 at % improves the insulation reliability, and Ni contained in the shell portion at a concentration of 0.3 at % to 3 at % and Fe contained in the shell portion at a concentration of 0.3 at % to 3 at % inhibit the occurrence of oxygen defects in barium titanate due to Ho, so as to achieve a high insulation reliability.

In samples 1 to 11, the concentration of Ni in the shell portion at 0.3 at % or more inhibits the solid solution of Ho into the B site and also inhibits the reduction of barium titanate during firing, and the concentration of Ni in the shell portion at 3 at % or less inhibits the occurrence of oxygen defects in barium titanate due to excessive amount of Ni. Thus, it is considered that high insulation reliability is achieved in samples 1 to 11 with the concentration of Ni in the shell portion within an appropriate range.

In samples 1 to 11, the concentration of Fe in the shell portion at 0.3 at % or more inhibits the solid solution of Ho into the B site and also inhibits the diffusion of Ni during firing, and the concentration of Fe in the shell portion at 3 at % or less inhibits the occurrence of oxygen defects in barium titanate due to excessive amount of Fe. Thus, it is considered that high insulation reliability is achieved in samples 1 to 11 with the concentration of Fe in the shell portion within an appropriate range.

In samples 1 to 11, the ratio of the sum of the concentration of Ni and the concentration of Fe to the concentration of Ho in the shell portion is 2 or less. In samples 1 to 11, high insulation reliability is achieved with the ratio of the sum of the concentration of Ni and the concentration of Fe to the concentration of Ho in the shell portion being 2 or less. In samples 1 to 11, it is considered that, with the ratio of the sum of the concentration of Ni and the concentration of Fe to the concentration of Ho in the shell portion being 2 or less, the effect of the improved insulation reliability by Ho contained in the shell portion exceeds the effect of the reduced insulation reliability by oxygen defects produced by Ni and Fe contained in the shell portion.

In samples 1 to 11, the ratio of the concentration of Fe to the concentration of Ni in the shell portion is 0.13 or more. In samples 1 to 11, the concentration of Fe is large relative to the concentration of Ni in the shell region, which inhibits excessive solid solution of Ni into the shell portion. Thus, it is considered that high insulation reliability is achieved in samples 1 to 11 by increasing the ratio of the concentration of Fe to the concentration of Ni in the shell portion, thereby inhibiting the occurrence of oxygen defects due to excessive solid solution of Ni.

The reason for the short average failure time in sample 12 is considered to be that the concentration of Ni is small relative to the concentration of Fe in the shell portion, and thus the diffusion of Ni is not sufficiently inhibited, resulting in 3.2 at % Ni solid solution in the shell portion, which increases the oxygen defect concentration.

The reason for the short average failure time in sample 13 is considered to be that the concentration of Fe in the shell portion is too low (less than 0.3), which does not sufficiently inhibit the solid solution of Ho into the B site.

The reason for the short average failure time in sample 14 is considered to be that the concentration of Ni in the shell portion is too low (less than 0.3), which does not sufficiently inhibit the solid solution of Ho into the B site.

The reason for the short average failure time in sample 15 is considered to be that the concentration of Fe in the shell portion is too high (greater than 3), resulting in a higher concentration of oxygen defects due to the excess Fe contained in the shell portion.

The reason for the short average failure time in sample 16 is considered to be that the concentration of Ho in the shell portion is too low (less than 0.5), which results in insufficient improvement of the insulation reliability by Ho.

The reason for the short average failure time in sample 17 is considered to be that the ratio of the sum of the Ni and Fe concentrations to the Ho concentration in the shell portion is too high (greater than 2), so that the effect of the reduced insulation reliability due to oxygen defects produced by Ni and Fe exceeds the effect of the improved insulation reliability by Ho contained in the shell portion.

The reason for the short average failure time in sample 18 is considered to be that the concentration of Ni in the shell portion is too high (greater than 3), resulting in a higher concentration of oxygen defects due to the excess Ni contained in the shell portion.

The reason for the short average failure time in sample 19 is considered to be that the concentration of Ho in the shell portion is too high (greater than 5), resulting in a higher concentration of oxygen defects due to the excess Ho contained in the shell portion.

The above confirmed that capacitors having an excellent insulation reliability can be obtained by setting the concentration of Ho in the shell portion of the crystal grains contained in the dielectric layers to be from 0.5 at % to 5 at %, the concentration of Ni in the shell portion to be from 0.3 at % to 3 at %, and the concentration of Fe in the shell portion to be from 0.3 at % to 3 at %.

It was also confirmed that capacitors having excellent insulation reliability can be obtained by setting the ratio of the sum of the Ni and Fe concentrations to the Ho concentration in the shell portion to 2 or less, even when the Fe concentration is near the lower limit (see, for example, samples 1 and 8).

It was also confirmed that the occurrence of oxygen defects due to Ni can be inhibited and capacitors having an excellent insulation reliability can be obtained, by setting the ratio of Fe concentration to Ni concentration in the shell portion to 0.1 or greater, even when the Ni concentration is near the upper limit.

### (4) NOTES

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (5) ADDITIONAL EMBODIMENTS

Embodiments disclosed herein also include the following.

### Additional Embodiment 1

A capacitor comprising:
a body having a first internal electrode layer, a second internal electrode layer, and a dielectric layer disposed between the first internal electrode layer and the second internal electrode layer, the dielectric layer containing crystal grains of barium titanate;
a first external electrode provided on the body so as to be electrically connected to the first internal electrode layer; and
a second external electrode provided on the body so as to be electrically connected to the second internal electrode layer,
wherein the crystal grains each include a core portion and a shell portion covering the core portion, the shell portion containing Ho, Ni, and Fe,
wherein concentration a, which represents a concentration of Ho in the shell portion, is from 0.5 at % to 5 at %,
wherein concentration b, which represents a concentration of Ni in the shell portion, is from 0.3 at % to 3 at %, and
wherein concentration c, which represents a concentration of Fe in the shell portion, is from 0.3 at % to 3 at %.

### Additional Embodiment 2

The capacitor of Additional Embodiment 1, wherein a ratio of a sum of the concentration b and the concentration c to the concentration a is 2 or less.

### Additional Embodiment 3

The capacitor of Additional Embodiment 1 or 2,
wherein the concentration a is from 1.5 at % to 3.5 at %,
wherein the concentration b is from 1 at % to 2.5 at %, and
wherein the concentration c is from 1 at % to 2.5 at %.

### Additional Embodiment 4

The capacitor of any one of Additional Embodiments 1 to 3, wherein a ratio of the concentration c to the concentration b is 0.1 or greater.

### Additional Embodiment 5

The capacitor of any one of Additional Embodiments 1 to 4, wherein a ratio of the concentration c to the concentration b is 0.15 or greater.

### Additional Embodiment 6

The capacitor of any one of Additional Embodiments 1 to 5, wherein a main component of the first internal electrode layer and the second internal electrode layer is Ni.

### Additional Embodiment 7

The capacitor of any one of Additional Embodiments 1 to 6, wherein a concentration of Ho in the core portion is 0.15 at % or less.

### Additional Embodiment 8

A circuit module comprising the capacitor of any one of Additional Embodiments 1 to 7.

### Additional Embodiment 9

An electronic device including the circuit module of Additional Embodiment 8.

### Additional Embodiment 10

A method of manufacturing a capacitor comprising the steps of:
preparing a compact including a dielectric green sheet and an internal electrode pattern, the dielectric green sheet containing Ho and Fe, the internal electrode pattern containing Ni;
performing a first heating process in which the compact is heated at a first temperature; and
performing a second heating process in which the compact heated in the first heating process is heated at a second temperature, the second temperature being higher than the first temperature.

### Additional Embodiment 11

The method of Additional Embodiment 10, wherein the dielectric green sheet contains a mixed powder made of BaTiO₃ powder, 0.350 mol to 1.000 mol of Ho₂O₃ powder relative to 100 mol of BaTiO₃ powder, and 0.050 mol to 1.000 mol of Fe₂O₃ powder relative to 100 mol of BaTiO₃ powder.

What is claimed is:

1. A capacitor comprising:
a body having a first internal electrode layer, a second internal electrode layer, and a dielectric layer disposed between the first internal electrode layer and the second internal electrode layer in a first direction, the dielectric layer containing crystal grains of barium titanate;
a first external electrode provided on the body so as to be electrically connected to the first internal electrode layer; and
a second external electrode provided on the body so as to be electrically connected to the second internal electrode layer,
wherein the crystal grains each include a core portion and a shell portion covering the core portion, the shell portion containing Ho, Ni, and Fe,
wherein concentration a, which represents a concentration of Ho in the shell portion, is from 0.5 at % to 5 at %,
wherein concentration b, which represents a concentration of Ni in the shell portion, is from 0.3 at % to 3 at %, and
wherein concentration c, which represents a concentration of Fe in the shell portion, is from 0.3 at % to 3 at %.

2. The capacitor of claim 1, wherein a ratio of a sum of the concentration b and the concentration c to the concentration a is 2 or less.

3. The capacitor of claim 1,
wherein the concentration a is from 1.5 at % to 3.5 at %,
wherein the concentration b is from 1 at % to 2.5 at %, and
wherein the concentration c is from 1 at % to 2.5 at %.

4. The capacitor of claim 1, wherein a ratio of the concentration c to the concentration b is 0.1 or greater.

5. The capacitor of claim 1, wherein a ratio of the concentration c to the concentration b is 0.15 or greater.

6. The capacitor of claim 1, wherein a main component of the first internal electrode layer and the second internal electrode layer is Ni.

7. The capacitor of claim 1, wherein a concentration of Ho in the core portion is 0.15 at % or less.

8. A circuit module comprising the capacitor of claim 1.

9. An electronic device comprising the circuit module of claim 8.

10. A method of manufacturing a capacitor comprising the steps of:
preparing a compact including a dielectric green sheet and an internal electrode pattern, the dielectric green sheet containing Ho and Fe, the internal electrode pattern containing Ni;
performing a first heating process in which the compact is heated at a first temperature; and
performing a second heating process in which the compact heated in the first heating process is heated at a second temperature, the second temperature being higher than the first temperature.

11. The method of claim 10, wherein the dielectric green sheet contains a mixed powder made of BaTiO₃ powder, 0.350 mol to 1.000 mol of Ho₂O₃ powder relative to 100 mol of BaTiO₃ powder, and 0.050 mol to 1.000 mol of Fe₂O₃ powder relative to 100 mol of BaTiO₃ powder.
